(19) United States
(12) Patent Application Publication
(10) Pub. No.: US 2009/0144457 A1
(43) Pub. Date: Jun. 4, 2009

(54) Plug and Play Device and Related Installing Method

(76) Inventor: Lian-Chun Lee, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/033,019

(22) Filed: Feb. 19, 2008

(30) Foreign Application Priority Data
Nov. 29, 2007 (TW) 096145362

(51) Int. Cl. G06F 3/00; G06F 13/20

(52) U.S. Cl. 710/10; 710/313

(57) ABSTRACT

A plug-and-play device is disposed for installing onto a computer. The plug-and-play device includes an ATA controller, a storage device, and a predetermined-function device. The ATA controller emulates a storage drive inserted in the computer to the OS of the computer. The OS continuously examines if the emulated storage drive is ready and when the emulated storage is drive ready, the OS reads the image of the emulated storage drive. The storage device stores the image of the emulated storage drive. The image includes a setup file and an auto-run file. The auto-run file includes an index indexing to the setup file. When the OS reads the auto-run file, the OS installs the setup file according to the index of the auto-run file.

### BACKGOUND OF THE INVENTION

1. Field of the Invention

The present invention relates to a plug-and-play device, and more particularly, to a plug-and-play device with auto-installation of driver programs.

2. Description of the Prior Art

As the computer industries progress, the plug-and-play function becomes more and more important. Nowadays most computer peripheral devices are designed with supporting plug-and-play functions, such as printers, scanners, modems, and display cards. Those plug-and-play devices are sold with disks or optical discs having drivers because they are not standard devices for computers. Therefore, a consumer has to install the driver of the plug-and-play device, which is stored in the optical disc, onto a computer before the plug-and-play device works regularly in the computer. The installation procedure is very tedious. For example, it is common for a user changing the Operation System (OS) or reinstalling the OS from time to time, and each time when the user reinstalls the OS, installation of the driver of the plug-and-play device is needed again. On the other hand, the disc with the driver for the plug-and-play device might be lost, which causes the device to not work in a computer without pre-installation and inconvenience for consumers.

### SUMMARY OF THE INVENTION

The present invention provides a plug-and-play device. The plug-and-play device is installed in a computer. The plug-and-play device comprises an ATA controller for emulating an emulated optical disc drive, notifying the OS of the computer so as to make the OS of the computer keep examining if the emulated optical disc drive is ready and read an image file of the emulated optical disc drive when the emulated optical disc drive is ready, a storage device coupled to the ATA controller for storing the image file of the emulated optical disc drive, the image file comprising a setup file for installing a driver of a predetermined function onto the OS of the computer, and an auto-run file comprising an index, the index indicating the setup file, wherein when the OS of the computer reads the auto-run file, the OS automatically executes the setup file and installs the driver, and a predetermined function device executing the predetermined function after the driver is installed onto the OS of the computer.

The present invention provides a method for installing a plug-and-play device. The plug-and-play device is installed in a computer. The method comprises emulating an optical disc drive and notifying the OS of the computer, the OS of the computer automatically reading an image file of the emulated optical disc drive, providing an auto-run file in the image file of the emulated optical disc drive, and the OS executing a setup file of a driver of the plug-and-play device according to an index of the auto-run file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a plug-and-play device of the present invention.

FIG. 2 is a flowchart of the installation of the plug-and-play device of the present invention.

### DETAILED DESCRIPTION

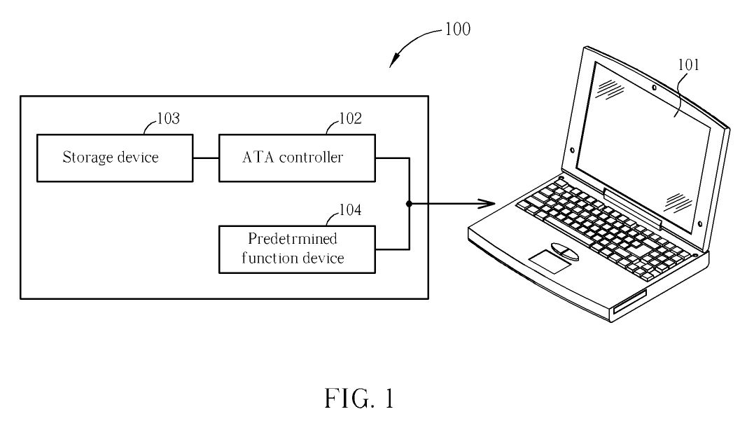

Please refer to FIG. 1. FIG. 1 is a diagram illustrating a plug-and-play device 100 of the present invention. As shown in FIG. 1, the plug-and-play device 100 comprises an Advanced Technology Attachment (ATA) controller 102, a storage device 103, and a predetermined function device 104. The plug-and-play device 100 is installed in a computer 101, and the plug-and-play device 100 automatically installs the driver of the predetermined function device 104, which allows the computer 101 to utilize the plug-and-play device 100 and execute the predetermined function. For example, the predetermined function device 104 can be a card reader, and after the driver installation of the card reader is finished, the computer 101 can utilize the card reader to read cards.

When the plug-and-play device 100 is coupled to the computer 101, the ATA controller 102 emulates an optical disc drive and notifies the OS of the computer 101 (for example, Windows). The characteristic of the optical disc drive is that when a disc exists in the optical disc drive, the optical disc drive notifies a ready signal to the computer 101, and when a disc does not exist in the optical disc drive, the optical disc drive does not notify a ready signal to the computer 101. Therefore, the OS of the computer 101 keeps inquiring if the emulated optical disc drive is ready. When the emulated optical disc drive is ready, the computer 101 accesses the data of the emulated optical disc drive (for example, image files). The image files are stored in the storage device 103 and accessed by the computer 101 through the ATA controller 102. Therefore, when the ATA controller 102 and the storage device 103 are both ready, the computer 101 accesses the image files in the storage device 103. The present invention disposes an auto-run file in the image files (for example, autorun.ini or autorun.exe), and the computer 101 automatically reads the data in the auto-run file. Further, the present invention disposes the setup file of the installation of the driver of the predetermined function device 104, and disposes an index in the auto-run file indicating the computer 101 to install the setup file of the installation of the driver of the predetermined function device 104. In this way, when the OS of the computer 101 reads the auto-run file, the OS automatically installs the setup file of the driver of the predetermined function device 104 according to the index. Consequently, the predetermined function device 104 can work regularly after the automatic installation.

Additionally, the interface between the plug-and-play device 100 of the present invention and the computer 101 can be Peripheral Component Interconnect (PCI), Peripheral Component Interconnect Express (PCIe), Universal Serial Bus (USB) or 1394.

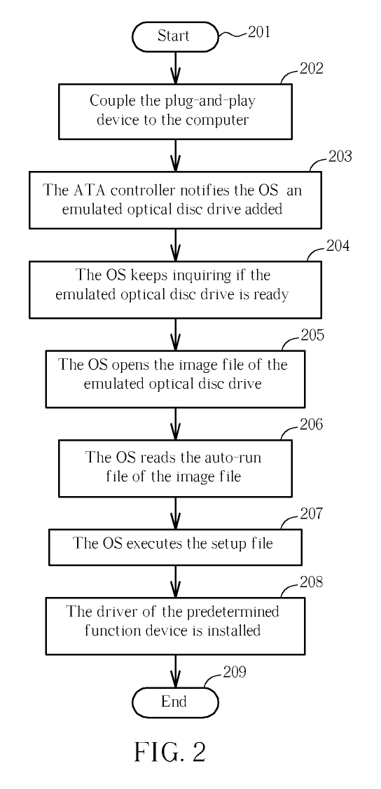

Please refer to FIG. 2. FIG. 2 is a flowchart of the installation of the plug-and-play device 100 of the present invention. The steps are described in details as follows.

Step 201: Start.

Step 202: Couple the plug-and-play device 100 to the computer 101.

Step 203: The ATA controller 102 notifies the OS of the computer 101 an emulated optical disc drive added.

Step 204: The OS of the computer 101 keeps inquiring if the emulated optical disc drive is ready through the ATA controller 102.

Step 205: The OS of the computer 101 opens the image file of the emulated optical disc drive.

Step 206: The OS of the computer 101 reads the auto-run file of the image file.

Step 207: The OS of the computer 101 executes the setup file of the installation of the driver of the predetermined function device automatically according to the index.

Step 208: The driver of the predetermined function device is installed in the OS of the computer 101.

Step 209: End.

Thus, the present invention provides automatic installation of the plug-and-play device, which allows the user not to have to keep the driver disc as the prior art, and increases convenience.

Those skilled in the art will readily observe that numerous modifications and alterations of the device and method may be made while retaining the teachings of the invention.

What is claimed is:

1. A plug-and-play device, the plug-and-play device installed in a computer, the plug-and-play device comprising:
an ATA controller for emulating an emulated optical disc drive, notifying an OS of the computer so as to make the OS of the computer keep examining if the emulated optical disc drive is ready and read a image file of the emulated optical disc drive when the emulated optical disc drive is ready;
a storage device coupled to the ATA controller for storing the image file of the emulated optical disc drive, the image file comprising:
a setup file for installing a driver of a predetermined function onto the OS of the computer; and
an auto-run file comprising an index, the index indicating the setup file, wherein when the OS of the computer reads the auto-run file, the OS automatically executes the setup file and installs the driver; and
a predetermined function device executing the predetermined function after the driver is installed onto the OS of the computer.

2. The plug-and-play device of claim 1 wherein an interface between the plug-and-play device and the computer is a PCI interface.

3. The plug-and-play device of claim 1 wherein an interface between the plug-and-play device and the computer is a PCIe interface.

4. The plug-and-play device of claim 1 wherein an interface between the plug-and-play device and the computer is a USB interface.

5. The plug-and-play device of claim 1 wherein an interface between the plug-and-play device and the computer is a 1394 interface.

6. The plug-and-play device of claim 1 wherein the predetermined function device is a card reader.

7. A method for installing a plug-and-play device, the plug-and-play device installed in a computer, the method comprising:
emulating an optical disc drive and notifying an OS of the computer;
the OS of the computer automatically reading an image file of the emulated optical disc drive;
providing an auto-run file in the image file of the emulated optical disc drive; and
the OS executing a setup file of a driver of the plug-and-play device according to an index of the auto-run file.

8. The method of claim 7 wherein an interface between the plug-and-play device and the computer is a PCI interface.

9. The method of claim 7 wherein an interface between the plug-and-play device and the computer is a PCIe interface.

10. The method of claim 7 wherein an interface between the plug-and-play device and the computer is a USB interface.

11. The method of claim 7 wherein an interface between the plug-and-play device and the computer is a 1394 interface.

12. The method of claim 7 wherein the predetermined function device is a card reader.
